(19) United States
(12) Patent Application Publication
(10) Pub. No.: US 2004/0071254 A1
(43) Pub. Date: Apr. 15, 2004

(54) Packaging device for bulk transportation of uraniferous fissile materials

(76) Inventor: Pierre Malalel, St. Medard En Jalles (FR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/451,645

(22) PCT Filed: Dec. 20, 2001
(86) PCT No.: PCT/FR01/04111

(30) Foreign Application Priority Data
Dec. 21, 2000 (FR) 00/16764

(51) Int. Cl. G21C 19/00

(52) U.S. Cl. 376/272

(57) ABSTRACT

A packaging device, for bulk transport of uraniferous fissile materials.

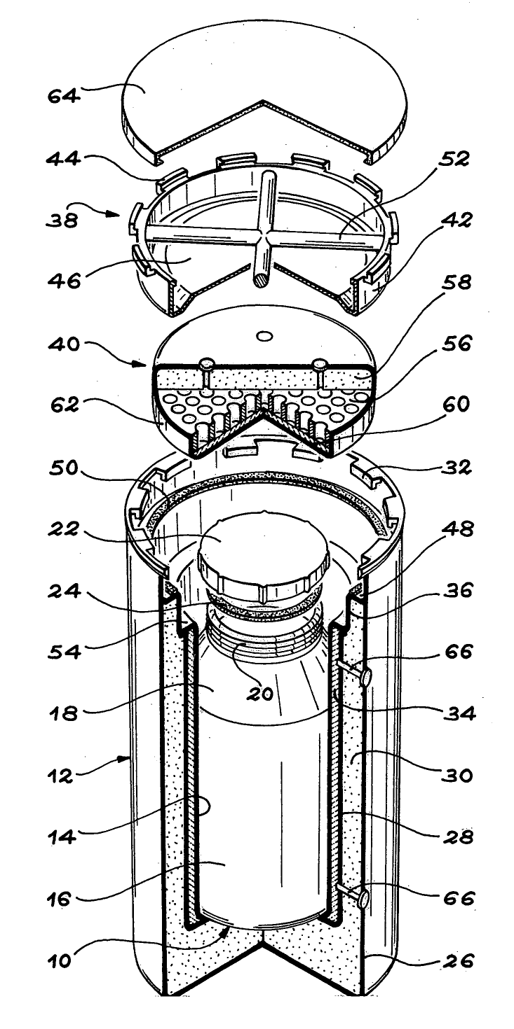

The device comprises an internal chamber (10) forming a confinement enclosure for the fissile materials it contains. This is advantageously made of high-density polyethylene. It is placed inside a container (12) formed by an external envelope (26) and an inner shaft (28) separated by a cellular material for thermo-mechanical protection, such as a phenolic foam. The design of the container (12) enables deformation of the chamber (10) likely to break the confinement of the fissile material to be limited, in the event of shock.

### TECHNICAL FIELD

The present invention relates to a packaging device for bulk transport of uraniferous fissile materials, in particular in the form of powder or pellets, in light of their transport.

The invention applies to the transport of all uraniferous fissile materials likely to cause a chain reaction, such as materials containing uranium 235. Among these materials, a particular example is powder and pellets of slightly enriched uranium oxide UO₂ that is, containing less than 5% uranium 235 by mass.

Prior Art

Existing containers intended for the transport of powder or pellets of uranium oxide comprise a hollow body, which internally delimits a closed cavity for accommodating the fissile materials. The hollow body is generally cylindrical in shape.

More precisely, the fissile materials are usually packaged in metallic chambers closed by covers with metallic screed. The external geometry of these chambers is designed so as to conform to that of the cavity delimited by the hollow body.

The hollow body of the container comprises, at least at one of its ends, an opening allowing access to the cavity, for inserting and withdrawing the chamber containing the fissile materials. Under normal transport conditions, this opening is sealed by a closing device such as a screwed-down stopper.

The transport of fissile materials is governed by international ruling which imposes increasingly severe conditions on containers utilised for this purpose.

These conditions concern preventing the risk of criticality, confinement of the material transported and protection of the public vis-à-vis ionising radiation.

In the first instance, a container suitable for holding fissile radioactive materials must be designed so as to avoid uncontrolled multiplication of neutrons emitted by these materials. On the contrary, if the chain reaction starts to run it could have serious consequences for persons located in the vicinity of the container. In fact, the latter would then be exposed to radiation due to the neutrons emitted quasi-instantaneously and in very large quantities.

This phenomenon is amplified whenever a large number of containers is placed in an array, in particular in the event where they would deteriorate as the result of an accident occurring during transportation. This is why regulations oblige containers intended for transporting fissile materials to undergo random testing for transport accident conditions.

Preventing the risk of criticality also requires confinement of the fissile materials. This function is assured by all the elements of the container which delimit the closed volume which can be occupied by the fissile materials. This set of elements forms what is known as the “confinement enclosure” of the container.

In existing containers, the confinement enclosure usually comprises the body of the container, its closing device and sealing means interposed between the latter.

Furthermore, the most recent international regulation imposes accountability for possible penetration of water into the confinement enclosure for evaluation of the sub-criticality of transport containers.

This reinforcement of the regulation is explained by the fact that, if the fissile materials are mixed with water, multiplication of the neutrons is greatly amplified by hydrogen contained in the water. The risks of a critical accident are then potentially increased.

In existing containers, any possible penetration of water into the confinement enclosure leads to a reduction in their transport capacity. This results in an increase in operating costs.

Furthermore, recent international regulation imposes testing during which a heavy plate is dropped onto the container standing on the ground.

This requirement concerns containers having a mass of less than 500 kg and a volumetric mass of less than 1000 kg/m³. It is thus applicable to the majority of existing containers utilised for the transport of uraniferous fissile materials, when the latter are in the form of powder or pellets of uranium oxide UO₂.

However, the structure of existing containers designed for transport of these materials is such that the consequence of this testing would be to lose the tightness of their confinement enclosure for powder or pellets.

Under these conditions, respect of the new regulation by containers of classic design would thus be translated by a new decrease in the volume of fissile material transportable in these containers.

In the more general domain of bulk transport of fluid materials, and in particular toxic or dangerous chemical products, the documents U.S. Pat. No. 5,395,007 and U.S. Pat. No. 5,595,319 both concern a reusable container. This container comprises a closed external enclosure and a closed internal enclosure, separated from one another and between which a cushioning material is interposed. Access orifices formed in each of the enclosures and connected by a deformable tubular element allow the entry and exit of the fluid materials. Distinct stoppers normally seal off each of these orifices.

### DESCRIPTION OF THE INVENTION

The object of the invention precisely is a packaging device intended for transporting uraniferous fissile materials in powder or in pellets, whereof the original design allows it to satisfy the most recent regulatory requirements, while preserving maximum transport capacity.

According to the invention this result is obtained by means of a packaging device, for bulk transport of uraniferous fissile materials, comprising a chamber for holding the fissile materials and a container delimiting a cavity for receiving the chamber, via a container opening, provided to be closed by a cover, characterised in that:

the chamber comprises a chamber opening, provided to be closed tightly by a stopper, to form with the latter a confinement enclosure for fissile materials;

the container comprises an external envelope, an inner shaft delimiting said cavity and a cellular thermo-mechanical material, placed in a space separating the external envelope from the inner shaft.

In this original arrangement, owing to the confinement enclosure being constituted by the chamber containing the bulk fissile material, closed by its stopper, a violent shock producing significant deformation of the container is without consequence on the confinement of said fissile material.

Protection of the confinement is also assured by the presence of the cellular material between the external envelope of the container and the inner shaft in which the chamber is placed. In fact, as it deforms progressively, this material cushions the shocks undergone by the external envelope and limits their transmission to the inner shaft. The cellular material also ensures thermal protection of the chamber vis-avis a possible fire.

According to a preferred embodiment of the invention, the stopper is screwed onto the opening of the chamber, with interposition of a gasket. This arrangement facilitates access to the inside of the chamber, at the same time allowing the confinement to be preserved in the event where a particularly severe shock would cause it to deform.

In this preferred embodiment, the chamber comprises a neck integrating the opening of the chamber, a main cylindrical part and a truncated part connecting the neck to the main cylindrical part. The truncated part of the chamber is then suitable for deforming without breaking the confinement, under the effect of a shock oriented along the axis of the chamber.

Advantageously, the opening of the chamber then has a diameter at least equal to 60% of the diameter of the main cylindrical part.

To further facilitate preserving confinement even in the event of limited deformation of the chamber and its stopper, the latter are preferably made of a material selected in the group comprising plastic materials, stainless steels and the aluminium alloys.

In the preferred embodiment of the invention, this material is high-density polyethylene.

Advantageously, the cellular thermo-mechanical protection material is phenolic foam.

In addition, the cover of the container preferably cooperates with the opening of the latter by a bayonet mechanism. This mechanism is opposed to any axial ejection of the chamber containing the fissile material, in the event of a violent shock.

In the preferred embodiment of the invention, a container stopper is provided to be interposed between the cover and the cavity suitable for receiving the chamber.

This container stopper advantageously integrates a perforated metallic plate, advantageously made of light alloy. This plate cushions the shocks undergone by the container, at the level of its opening, in a radial direction. Thus it also contributes to avoiding excessive deformation of the chamber and, consequently, to preserving its confinement.

In this case, a layer of the cellular material and a layer of a thermal protection material such as plaster are also integrated in the stopper of the container, for example on the external and internal faces of the perforated plate, respectively.

In order to ensure protection of the public from the ionising radiation, the inner shaft comprises a peripheral wall which integrates a neutrophagic screen. This peripheral wall is completed by a base wall.

### BRIEF DESCRIPTION OF DIAGRAMS

A preferred embodiment of the invention will now be described, by way of a non-limiting example, with reference to the attached diagram, wherein the sole FIGURE is an exploded perspective view, with parts removed, which illustrates a confinement device according to the present invention.

### DETAILED DESCRIPTION OF A PREFERRED EMBODIMENT OF THE Invention

As illustrated in the sole FIGURE, the confinement device according to the present invention mainly comprises a chamber 10, for containing bulk uraniferous fissile materials, and a container 12 internally delimiting a cavity 14 in which the chamber 10 can be placed.

The term “bulk uraniferous fissile materials” designates in this case, as well as throughout the text, all fissile materials containing uranium and in the form of a powder, pellets or any other comparable form. It should be noted that bulk fissile materials can be placed either directly inside the chamber 10, or in one or more pockets made of a flexible plastic material facilitating handling, in turn placed in the chamber 10.

Among fissile materials, the invention is applied advantageously, although non-exclusively, to the transport of powder and pellets of uranium oxide UO₂ containing less than 5% by mass of uranium 235.

The confinement device illustrated in the figure conventionally demonstrates a cylindrical geometry. As a consequence, the chamber 10 and the container 12 both have a longitudinal axis generally oriented in a vertical direction.

The chamber 10 comprises a main cylindrical part 16, of uniform diameter, closed towards the base by a planar end, not visible in the figure. The main cylindrical part 16 is lengthened upwards by a truncated part 18. At the upper end of the truncated part 18, the chamber terminates in a neck 20, fitted with a thread on its external peripheral surface. The neck 20 delimits internally an opening via which the fissile materials can be introduced into the chamber 10 and removed therefrom.

A chamber stopper 22 is provided to be screwed onto the thread of the neck 20, with interposition of a gasket 24, for tightly closing the opening of the chamber 10.

More precisely, the gasket 24 is a plane annular joint, rectangular in section, provided to be interposed between two opposite flat surfaces formed respectively in the base of the stopper 22 and on the upper end edge of the neck 20. To make handling easier, the gasket 24 is preferably enclosed in the base of the stopper 22, such that it is connected to the latter when it is being screwed and unscrewed.

In the abovementioned arrangement the chamber 10, sealed tightly by its stopper 22 with interposition of the gasket 24, forms a confinement enclosure for the fissile materials it contains. In other words, the bulk fissile materials contained in the chamber 10 are confined vis-à-vis the exterior by this same chamber, when it is closed by its stopper 22.

The chamber 10 as well as its stopper 22 are made of a material such as a plastic material, stainless steel or aluminium alloy.

In the preferred embodiment of the invention, this material is high-density polyethylene. Using this material effectively guarantees preservation of the confinement of fissile materials even in the hypothetical situation of geometric deformation of the chamber and/or its stopper. In effect, the high-density polyethylene has a flexibility and an elasticity enabling significant geometric deformation without the risk of rupture. In addition, this material deforms in such a way that possible ovalisation of the opening of the chamber is accompanied by comparable ovalisation of the stopper, such that tightness ensured by the joint 24 is maintained.

The elastic deformation of the high-density polyethylene combined with the truncated shape of the part 18 of the chamber 10 avoids rupture of the confinement when the chamber is compressed along its longitudinal axis. In effect, this is then translated by a simple decrease in length of the part 18.

It should be noted that the aptitude of the chamber 10 to deform without breaking its seal enables the diameter of the opening formed in the neck 20 to be given a relatively high value, in turn making it easier to fill and empty the chamber. Thus, the diameter of the opening of the chamber 10 is advantageously at least equal to 60% of the diameter of the main cylindrical part of the chamber.

As illustrated by the sole figure, the container 12 mainly comprises an external envelope 26 and an inner shaft 28 delimiting the cavity 14. These two components are separated by a space filled by a cellular material 30 for thermo-mechanical protection.

More precisely, the external envelope 26 is made up from sheet metal, preferably stainless steel. This sheet metal comprises a cylindrical part, of constant diameter, and a generally flat base part. The upper end of the abovementioned cylindrical part is open and fitted on its internal face of the female part 32 with a bayonet mechanism.

The inner shaft 28 is also made by means of sheet metal, preferably stainless steel. This sheet metal comprises a cylindrical part, of constant diameter, and a generally flat base part. These two parts are spaced at all points of the corresponding parts of the external envelope 26, to arrange on the periphery and in the base of the container 12 said space wherein the cellular material 30 is received.

In addition, the cylindrical part of the inner shaft comprises two coaxial metallic walls, between which a material neutrophagic 34 is enclosed. This material is a neutrophagic resin, which ensures prevention of critical risk.

The upper end of the inner shaft 28 is open, so as to allow the chamber 10 to be inserted into the cavity 14 and to be removed therefrom, when the elements which normally ensure closing of the container 12 are removed.

The inner shaft 28 is connected mechanically to the external envelope 26 by a stepped wall 36, also made of stainless steel. This wall 36 connects the upper end of the inner shaft 28 to the upper end of the external envelope 26, below the female part 32 of the bayonet mechanism. In this way, the wall 36 also closes the space which receives the cellular material 30 towards the top.

In the preferred embodiment of the invention as shown in the figure, the cellular material 30 is constituted by phenolic foam.

The advantage of this material is that it deforms identically or very similarly, irrespective of the direction of the effort being applied. It thus ensures cushioning for isotropic and efficacious shocks, irrespective of the drop angle of the container.

The advantages of the phenolic foam are also that it auto-extinguishable and has minimal thermal conductivity as well as good resistance to temperature. It therefore also ensures very good thermal protection of the chamber 10.

As shown in the sole FIGURE, the opening formed at the upper end of the container 12 for introducing and removing the chamber 10 is normally closed by a cover 38, under which a container stopper 40 is placed.

More precisely, the cover 38 is a metallic part, preferably made of stainless steel. It comprises a peripheral part 42, comprising on its external surface a male part 44 of the bayonet mechanism whose female part 32 is carried by the upper part of the external envelope 26. The male part 44 and female part 32 of the bayonet mechanism are provided to cooperate between one another in order to strengthen the cover 38 of the container 12 when they are engaged. The peripheral part 42 of the cover 38 is then lodged in the upper part of the external envelope 26.

The cover 38 also comprises a base 46 whereof a peripheral region, projecting downwards, is provided to be supported against an upper shoulder 48 of the stepped wall 36, when the male 44 and female 32 parts are engaged. A neatness joint 50, made of foam, is stuck onto the upper shoulder 48. This joint prevents dust and humidity penetrating under the cover 38. All the same, in no way does this constitute a gasket comparable to the joint 24 which ensures confinement of the fissile materials inside the chamber 10.

The cover 38 further comprises a prehensile part, such as a cross-piece 52, placed inside the peripheral part 42, above the base 46. This prehensile part allows an operator to turn the cover 38 in one direction or the other, according to how he wishes to close or open the container 12.

Furthermore, a device (not shown) is provided to oppose any rotation of the cover 38 when the male 44 and female parts 32 are engaged. This device comprises, for example, a blocking slug placed in a hole which radially passes through the upper part of the external envelope 26, as well as the peripheral part 42 of the cover. The anti-rotation device can also comprise a cable to be sealed in to a hole comparable to the preceding.

The stopper 40 of the container 12 is placed below the cover 38, so that it rests on a low shoulder 54 of the stepped wall 36, without interposition of a joint. The stopper 40 is then spaced away from the lower face of the cover 38 and the upper face of the stopper 22 of the chamber 10, when such a chamber is placed in the cavity 14.

The stopper 40 of the container 12 has the shape of a disc externally. It comprises a perforated plate 56, placed between an upper layer 58 of thermo-mechanical protection and a lower layer 60 of thermal protection. A metallic lining 62, preferably made of stainless steel, envelops the resulting whole.

The perforated plate 56 is a solid metallic plate, preferably made of aluminium alloy. It is penetrated over its entire thickness and its entire surface by perforations, for example of circular cross-section, as illustrated in the figure.

The function of the perforated plate 56 is to cushion the shocks applied radially to the external envelope 26 of the container 12, near the access opening provided in the upper part of the latter. The cushioning is attained by controlled deformation of the plate 56 in the radial direction, made possible by the presence of the perforations. It is translated by controlled ovalisation of the upper part of the container 12, without rupture of the confinement of the chamber 10.

On the contrary, a shock exerted along the axis of the container 12 is not cushioned by the plate 56, but by the thermo-mechanical protection layer 58 which overhangs it. This protective layer 58 is advantageously made of the same cellular material 30 as that which is interposed between the external envelope 26 and the inner shaft 28, that is, of phenolic foam.

Just like the cellular material 30, the layer 58 of cellular material at the same time ensures mechanical protection and thermal protection of the chamber 10.

The function of the lower layer 60 is to complete thermal protection, near the opening of the container 12. It is preferably made of plaster.

To reduce handling during loading and unloading operations, as well as the risk of human error while the confinement device is being closed, a flexible small chain can be used, optionally, to connect the stopper 40 and the cover 38. This small chain is made, for example, of stainless steel.

To avoid humidity collecting on the cover 38, in the event of intermediate storage outside, a protection cap 64, made of a plastic material, can be placed above the cover 38. The cap 64 is then nested on the upper edge of the external envelope 26 of the container 12.

The confinement device according to the present invention, such as has just been described by way of example with reference to the sole figure, easily maintains the confinement of the bulk uraniferous fissile materials id contains, under all circumstances provided by the strictest regulations. This result is gained due to joint use of an internal chamber impervious to the finest powders, thus constituting a confinement enclosure for said materials, and a container whose design effectively avoids deformation of the chamber which is likely to break said confinement.

As the figure shows, vents 66 pass through the external envelope 26, the cellular material 30 and the external wall of the inner shaft 28. These vents 66 are normally blocked by meltable pellets near the envelope 26. They allow evacuation of the gases liberated by the neutrophagic resin 34 and by the cellular material 30, in the event of fire. Comparable vents can also be provided in the stopper 40 of the container 12.

1. A packaging device, for bulk transport of uraniferous fissile materials, comprising a chamber (10) suitable for containing the fissile materials and a container (12) delimiting a cavity (14) for receiving the chamber (10), via a container opening, provided to be closed by a cover (38), characterised in that:
the chamber (10) comprises a chamber opening, provided to be closed tightly by a stopper (22), to form with the latter a confinement enclosure for fissile materials;
the container (12) comprises an external envelope (26), an inner shaft (28) delimiting said cavity (14) and a cellular material (30) for thermo-mechanical protection, placed in a space separating the external envelope (26) from the inner shaft (28).

2. The device as claimed in claim 1, wherein the stopper (22) is screwed onto the opening of the chamber (10), with interposition of a gasket (24).

3. The device as claimed in either of claims 1 and 2, wherein the chamber (10) comprises a neck (20) integrating the opening of the chamber, a main cylindrical part (16) and a truncated part (18) connecting the neck (20) to the main cylindrical part (16).

4. The device as claimed in claim 3, wherein the opening of the chamber (10) has a diameter at least equal to 60% of the diameter of the main cylindrical part (16).

5. The device as claimed in any one of claims 1 to 4, wherein the chamber (10) and its stopper (22) are made of a material selected from the group comprising plastic materials, stainless steels and aluminium alloys.

6. The device as claimed in claim 5, wherein said material is high-density polyethylene.

7. The device as claimed in any one of claims 1 to 6, wherein the cellular thermo-mechanical protection material is a phenolic foam.

8. The device as claimed in any one of claims 1 to 7, wherein the cover (38) is suitable for cooperating with the opening of the container (12) by a bayonet mechanism (32, 44).

9. The device as claimed in any one of claims 1 to 8, wherein a container stopper (40) is provided to the interposed between the cover (38) and the cavity (14) suitable for receiving the chamber (10).

10. The device as claimed in claim 9, wherein the container stopper (40) integrates a perforated metallic plate. (56).

11. The device as claimed in claim 10, wherein the container stopper (40) also integrates a layer (58) of said cellular material and a layer of thermal protection (60).

12. The device as claimed in any one of claims 1 to 11, wherein the inner shaft (28) comprises a peripheral wall and bottom wall, and the peripheral wall integrates a neutrophagic screen (34).
